(19) United States
(12) Patent Application Publication
(10) Pub. No.: US 2022/0276382 A1
(43) Pub. Date: Sep. 1, 2022

(54) HOMODYNE RECEIVE ARCHITECTURE IN A SPATIAL ESTIMATION SYSTEM

(71) Applicant: BARAJA PTY LTD, North Ryde, New South Wales (AU)

(72) Inventor: Fernando Diaz, North Ryde, New South Wales (AU)

(21) Appl. No.: 17/624,558

(22) PCT Filed: Jul. 6, 2020
(86) PCT No.: PCT/AU2020/050707

§ 371 Date: Jan. 3, 2022

(30) Foreign Application Priority Data
Jul. 4, 2019 (AU) 2019902371

(51) Int. Cl. G01S 17/89; G01S 7/481

(52) U.S. Cl. CPC G01S 17/89; G01S 7/4816; G01S 7/4814

(57) ABSTRACT

A method of detection of transmitted light reflected from an environment, an optical system for spatial estimation and associated components are described. Outgoing light is provided for spatial estimation, which may include wavelength channels directed by a beam director. A local oscillator signal is used in the detection of reflected light of the wavelength channels. A divider is used to divide the received light into a plurality of light signals, which are combined with a local oscillator signal, which may possess different temporal phase across at the light signals, to provide a plurality of signals for detection by light detectors for processing into a spatial estimation of the remote environment.

### RELATED APPLICATIONS

The disclosure of the present application is related to PCT application no. PCT/AU2016/050899 published as WO 2017/054036 A1 on 6 Apr. 2017, PCT application no. PCT/AU2017/051255 published as WO 2018/090085 A1 on 24 May 2018, PCT application no. PCT/AU2018/050961 published as WO 2019/046895 A1 on 14 Mar. 2019, and PCT application no. PCT/AU2018/051175 published as WO 2019/084610 A1 on 9 May 2019. The entire disclosure of each of these publications is incorporated herein by reference.

### FIELD OF THE DISCLOSURE

The present disclosure generally relates to the field of optical signal collection and detection. Disclosed embodiments relate to a system and method for reflected signal collection in a spatial estimation system.

### BACKGROUND

Spatial profiling refers to the mapping of an environment as viewed from a desired origin point. Each point or pixel in the field of view is associated with a distance to form a representation of the environment. Spatial profiles may be useful in identifying objects and/or obstacles in the environment, thereby facilitating automation of tasks.

One technique of spatial profiling involves sending light into an environment in a specific direction and detecting any light reflected back from that direction, for example, by a reflecting surface in the environment. The reflected light carries relevant information for determining the distance to the reflecting surface. The combination of the specific direction and the distance forms a point or pixel in the representation of the environment. The above steps may be repeated for multiple different directions to form other points or pixels of the representation, thereby facilitating estimation of the spatial profile of the environment within a desired field of view.

As one example optical signal collection and detection method, a direct detection (DD) method may be employed at a receiver side using avalanche photodiodes (APDs). As the name suggested, collected optical signals, including the intended optical signal at frequency f_{c}, are directly detected by the APD and converted to an electrical signal for further signal processing.

Alternatively, homodyne detection may be employed as the optical detection method, in which the collected signal is combined with a local oscillator signal. The combined optical signal may be subsequently detected by a PIN photodiode (PIN PD) and converted to an electrical signal for further signal processing. When the optical frequency of the local oscillator (f_{LO}) is the same as f_{c}(i.e. f_{LO}=f_{c}), the detection method is acknowledged as homodyne detection (HD). When the optical frequency of the local oscillator is different from f_{c}(i.e. f_{LO}≠f_{c}), the detection method is acknowledged as heterodyne detection.

### SUMMARY OF THE DISCLOSURE

Methods and apparatus for detecting light by a light receiver are described. The method and apparatus may, for example, be used in spatial estimation systems, in which case the light received and detected may be light reflected by objects in an environment.

By way of example, the method may include receiving multimode light and separating the multimode light, for example by a photonic lantern, into a plurality of single mode light signals. A photodetector can then detect each of the plurality of single mode light signals and provide an output indicative of the detected light. A processor may be configured to process the output from the photodetectors to provide a further output indicative of the detected multimode light.

The method may include detecting one of the single mode light signals by combining the signal with a local oscillator signal with a first temporal phase and another of the single mode light signals by combining the signal with a local oscillator signal with a second temporal phase. The different first and second temporal phases may be derived from temporal phase noise, which may originate from a light source of outgoing light of the spatial estimation system.

The method may include causing receipt of the multimode light by generating and transmitting into an environment an unpolarised light signal, wherein the received multimode light includes the unpolarised light signal reflected back from the environment.

In some embodiments, a method of detection of light reflected from an environment includes: receiving light reflected from an environment; splitting the light reflected from the environment into a plurality of reflected light signals; combining a local oscillator signal with each of the plurality of reflected light signals, to produce a plurality of mixed signals; and detecting each of the plurality of mixed signals by a light receiver.

In some embodiments, the received light reflected from an environment has a plurality of light modes and splitting the light reflected from the environment into the plurality of reflected light signals comprises splitting the received light into a plurality of light signals each with a single light mode.

In some embodiments, the method further comprises using as the local oscillator signal, an unpolarised light signal comprising a sample of artificially generated outgoing light into the environment occasioning at least a portion of the light reflected from the environment. In some other embodiments, the method may further comprise using as the local oscillator signal, an unpolarised light signal operating at the same or substantially the same centre wavelength as artificially generated outgoing light into the environment occasioning at least a portion of the light reflected from the environment.

In some embodiments, the light reflected from the environment is received via a wavelength dependent bidirectional beam director and the outgoing light is provided into the environment via the bidirectional beam director, wherein reflected light shares at least part of an optical path of the outgoing light within the beam director.

In some embodiments, an optical system includes at least one optical assembly arranged to: receive an optical local oscillator signal; receive an optical remote light signal; provide a plurality of optical combined signals based on the local oscillator signal and the remote light signal, wherein each of the plurality of combined signals is formed based on a portion, less than all, of the received light signal; a plurality of light receivers arranged to receive the combined signals and provide, based on the received combined signals, a plurality of electrical signals carrying information indicative of at least one characteristic of the received reflected light signal; one or more electrical signal processors configured to receive the plurality of electrical signals and provide, based on the received electrical signals, an electrical output signal carrying information indicative of the at least one characteristic of the received light signal.

In some embodiments, the plurality of light receivers utilise photodiode detectors.

In some embodiments, the optical remote light signal is received by the optical assembly via a few mode or multimode optical fibre. The optical assembly may interface the few mode or multimode optical fibre with a plurality of single mode optical fibres, each single mode optical fibre carrying a said portion of the received light signal.

In some embodiments an optical system for spatial estimation includes: at least one light emitter operatively connected to optical components, configured or collectively configured to provide: outgoing light for spatial estimation, the outgoing light including: a first set of one or more wavelength channels for a duration of time; and a second set of one or more wavelength channels, different from the first set, for the same or a different duration of time; at least one local oscillator signal usable for detection of the outgoing light, including the first set of one or more wavelengths and the second set of one or more wavelengths; at least one beam director, for receiving the outgoing light and directing the outgoing light over free space into an environment remote from the beam director, the beam director configured to direct the first and second sets of one or more wavelengths in different directions; components to receive light from at least the different directions, including reflected light of the first and second sets of one or more wavelengths, the components including: at least one optical power splitter for splitting the power of the received light into a plurality of light signals each having non-zero power; at least one optical combiner to combine a said local oscillator signal and each of the plurality of light signals, to provide a combined signal for detection of the reflected light; wherein the at least one optical combiner and the at least one optical power splitter provide a plurality of said combined signals for detection; a plurality of light detectors arranged to receive the plurality of combined signals and provide, based on the received combined signals, a plurality of electrical signals for processing into a spatial estimation of the remote environment.

In some embodiments, the optical components operatively connected to the light emitter includes a depolariser operatively positioned to depolarise the outgoing light, whereby the outgoing light directed over free space into the environment is unpolarised light.

In some embodiments, the optical components operatively connected to the light emitter includes a depolariser operatively positioned to depolarise the at least one local oscillator signal for receipt by the optical combiner.

In some embodiments, the depolariser operatively positioned to depolarise the outgoing light and the depolariser operatively positioned to depolarise the at least one local oscillator signal are the same depolariser.

In some embodiments, each depolariser is a passive depolariser.

In some embodiments, the at least one light emitter is an incoherent light source. The incoherent light source may be an incoherent tunable laser.

In some embodiments, the optical power splitter is a photonic lantern connected to single mode optical fibres, the single mode optical fibres carrying the plurality of light signals.

In some embodiments a method of spatial estimation of an environment includes: directing, by a light director, unpolarised light over free space into an environment; receiving the unpolarised light reflected by the environment; and applying detection to the received unpolarised light, wherein applying detection includes power splitting the received unpolarised light and then combining with a local oscillator signal, to produce a plurality of detection signals; generating, by a processor, a spatial estimation of the environment based on a selected one or more of, or all, of the plurality of detection signals.

In some embodiments, the unpolarised light directed over free space into the environment is incoherent light.

In some embodiments, the unpolarised light directed over free space into the environment is spatially coherent light.

In some embodiments an optical system for spatial estimation includes: at least one light emitter operatively connected to optical components, configured or collectively configured to provide: outgoing light for spatial estimation, wherein the outgoing light is unpolarised light; and at least one local oscillator signal usable for detection of the outgoing light; at least one beam director, for receiving the outgoing light and directing the outgoing light over free space into an environment remote from the beam director; optical components to receive reflections of the directed outgoing light, including a plurality of optical combiners and at least one power splitter, operatively connected to produce a plurality of combined signals for detection based on light received by the light receiver and the at least one local oscillator signal; and a plurality of light detectors arranged to receive the plurality of combined signals and provide, based on the received combined signals, a plurality of electrical signals for processing into a spatial estimation of the remote environment.

In some embodiments, the power splitter is a photonic lantern interfacing between a few mode or multimode fibre carrying the received reflections and a plurality of single mode fibres connected to the optical combiners.

In some embodiments, the plurality of optical combiners and the at least one power splitter are integrated on a single photonic chip. Each of a plurality of output ports of the single photonic chip may align with one of the light detectors.

Further aspects of the present disclosure and further embodiments of the aspects described above will be apparent from the following disclosure, including with reference to the accompanying drawings.

### BRIEF DESCRIPTION OF THE DRAWINGS

FIG. 1A illustrates an arrangement of a spatial profiling system with direct detection (DD).

FIGS. 1B and 1C illustrate arrangements of a spatial profiling system with homodyne detection (HD).

FIG. 2 illustrates an arrangement of a spatial profiling system with a Multimode Homodyne Detection (MHD) receive architecture.

FIG. 3 illustrates an example of experimental results regarding polarisation measurements of an arbitrary signal after passing through a passive depolariser.

FIG. 4 illustrates one arrangement of a sensor head.

FIG. 5 illustrates an arrangement of an optical subassembly for MHD.

FIG. 6 illustrates an arrangement of a light receiver for MHD.

FIG. 7 illustrates one arrangement of a receive combiner for MHD.

FIG. 8 illustrates results of average optical power of the reflected signal collected by different detection methods

FIG. 9A illustrates measurements of intensity variation for three different detection methods as a function of optical power of outgoing light to an environment.

FIG. 9B illustrates distance accuracy measurements for the three detection methods as a function of optical power of the outgoing light to the environment.

FIG. 9C illustrates measurement of probability of detection for the three different detection methods as a function of optical power of the outgoing light to the environment.

### DETAILED DESCRIPTION OF EMBODIMENTS

Disclosed herein is an optical signal collection and detection method and apparatus for performing optical signal collection and detection. At least certain embodiments of the method and apparatus may be part of or used for a method or system for facilitating estimation of a spatial profile of an environment, based on a light detection and ranging (LiDAR) based technique. “Light” hereinafter includes electromagnetic radiation having optical frequencies, including infrared radiation, visible radiation and ultraviolet radiation. In this specification, “intensity” means optical intensity and, unless otherwise stated, is interchangeable with “optical power”.

In general, LiDAR involves transmitting light into the environment and subsequently detecting reflected light returned by the environment. By determining the time it takes for the light to make a round trip, the distance of surfaces within a field of view can be determined and an estimation of the spatial profile of the environment may be formed. In one arrangement, the present disclosure facilitates spatial profile estimation based on directing light over one dimension, such as along the vertical direction. In another arrangement, by further directing the one-dimensionally directed light in another dimension, such as along the horizontal direction, the present disclosure facilitates spatial profile estimation based on directing light in two dimensions. The distance to surfaces represents a third dimension in a three-dimensional environment in which a LiDAR system typically operates.

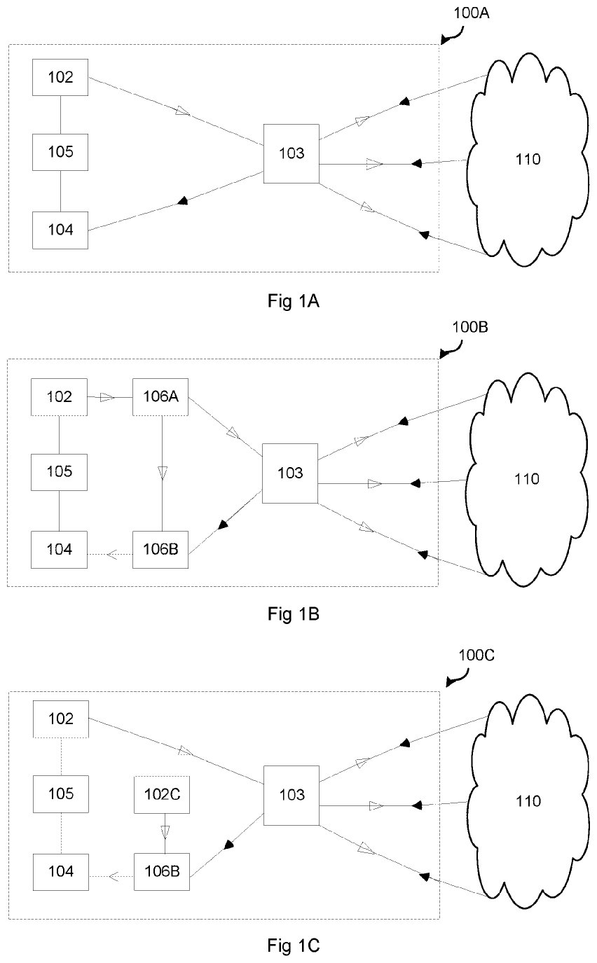

FIG. 1A illustrates an example arrangement of a spatial profiling system 100A with direct detection (DD). The system 100A includes a light source 102, a beam director 103, a light receiver 104 and a processing unit 105. In the arrangement of FIG. 1A, light from the light source 102 is directed by the beam director 103 in a direction across one or two dimensions into an environment 110 having a spatial profile. In many applications, for example LiDAR, the spatial profile includes a variable depth dimension, transverse to the one or two dimensions. If the outgoing light hits an object or a reflecting surface, at least part of the outgoing light may be reflected (represented in the solid arrows), e.g. scattered, by the object or reflecting surface back to the beam director 103 and received at the light receiver 104. As the name of “direct detection” suggests, the intensity of the reflected signal is directly detected by the light receiver that includes a light detector, which may include an avalanche photodiode (APD), and is converted to an electrical signal for further signal processing. The processing unit 105 is operatively coupled to the light receiver 104 for controlling its operations, to generate a measure of the received signal indicative of the output power received by the light detector, and for performing relevant signal processing including but not limited to determining the distance to the reflecting surface, by determining the round-trip time for the reflected light to return to the beam director 103. The processing unit 105 is also operatively coupled to the light source 102 for controlling its operations.

The system with DD may employ multimode fibres and APDs to collect and detect the reflected light. The multimode fibres can collect more signal compared to single mode fibres as they are less sensitive to spatial coherence and commonly have a higher numerical aperture. The APDs have better receiver sensitivity compared to PIN PD, due to possessing a gain stage which amplifies the signal current via avalanche multiplication. However, such an approach may be susceptible to interference from unintended light, such as ambient light, because multimode fibres are prone to collect stray light and APDs have a relatively broad detection bandwidth.

This issue may be mitigated by employing homodyne detection (HD), which enables a frequency sensitive optical gain to make the LiDAR system more immune to unintended light sources, such as ambient light and light from other LiDAR systems. As HD depends on the temporal and spatial coherence of the reflected signal, a single mode fibre may be used in place of the multimode fibre, making the system less susceptible to stray light. As HD does not directly measure the intensity of the return signal but measures instead a small AC signal upon a large DC background, a photodiode (PD) may be used in place of the APD for its larger dynamic range and linearity. Furthermore, the measured homodyne signal depends on the square root of the reflected signal power, further improving the dynamic range of the system.

FIG. 1B illustrates an example arrangement of a spatial profiling system 100B with HD. In the arrangement of FIG. 1B, light from the light source 102 is also provided to the light receiver 104. For example, the light from the light source 102 may first enter a sampler 106A (e.g. an optical coupler or an optical splitter), where a first portion of the light is provided to the beam director 103 as outgoing light for environment sensing and a second portion (e.g. the remaining sample portion) of the light is provided as a local oscillator (LO) signal. The second portion of the light is combined with the reflected light via an optical combiner 106B (e.g. an optical coupler). The combined light is then fed into the light receiver 104 which detects the beat signal of the combined light. The light receiver 104 includes a light detector, which may, for example, be in the form of a PD (not an APD) for single ended detection or be in the form of two PDs for balanced detection.

In another example, the light from the light source 102 may first enter an input port of an optical switch and exit from one of two output ports, where one output port directs the light to the beam director 103 and the other output port re-directs the light to the optical combiner 106B at a time determined by the processing unit 105. At least one optical delay (not shown) may be applied to synchronise the local oscillator signal and the reflected light at the optical combiner 106B.

When light from the light source 102 is directed to both the beam director 103 and the light receiver 104, the proportion to the beam director will typically be much smaller, for example 10% or less. An optical amplification stage will amplify the portion to the beam director, to provide sufficient power of output light for spatial profiling.

In another arrangement of a spatial profiling system 100C with homodyne detection as shown in FIG. 1C, the LO signal may be provided by a light source 102C separate from the light source 102. The LO signal from the light source 102C is provided to the optical combiner 106B and is operatively controlled by the processing unit 105. In one example, the light source 102C may be controlled to emit light with the same centre frequency as that of the light emitted from the light source 102. The processing unit 105 may also control the output power and operation time of the light source 102C. The optical combiner 106B combines the LO signal and the reflected signal and outputs the combined optical signal to the light receiver 104.

As previously mentioned, immunity to unintended light sources may be improved using homodyne detection (HD). However, LiDAR systems using HD are also polarisation sensitive. Signal loss may occur due to a polarisation state mismatch between the LO signal and the reflected signal. Additionally, LiDAR systems using HD may require coherent light sources for temporal stability, due to their phase sensitive nature. Still further, LiDAR may suffer from spatial incoherence or speckle noise, for example arising from coherent outgoing light reflecting off a diffuse target. Polarisation and phase noise may be overcome by employing quadrature detection techniques, however, quadrature detection is insufficient to mitigate speckle noise. In order to reduce speckle noise, the outgoing light generally requires to be scanned over the targeting surface, which is difficult to achieve in short acquisition windows (e.g. ˜10 MHz) as required for LiDAR systems requiring fast scanning speeds. Alternatively, speckle noise may be reduced using multimode fibre receivers, however, it is not compatible with HD.

Having identified deficiencies as discussed above, the inventors have devised several arrangements of spatial profiling systems that provide a useful alternative. Embodiments of the present disclosure may allow high scanning speeds and one or more of mitigation of signal degradation or instability effects caused by polarisation dependence, ambient light noise, temporal phase noise, and spatial phase noise. The disclosed embodiments of the spatial profiling systems may therefore support high-resolution LiDAR applications with high scanning speeds and improved received signal quality and dynamic range. In general and by way of example, the arrangements modify the homodyne detection systems described above to separate a received light signal into a plurality of signals each of which are mixed with an LO signal. The plurality of mixed signals are used for subsequent processing. While the description hereinafter refers to optical fibres (such as single mode fibres and multimode fibres), a skilled person in the art would appreciate that the description is equally applicable to, with minor modifications, to optical waveguides (such as single mode waveguides and multimode waveguides).

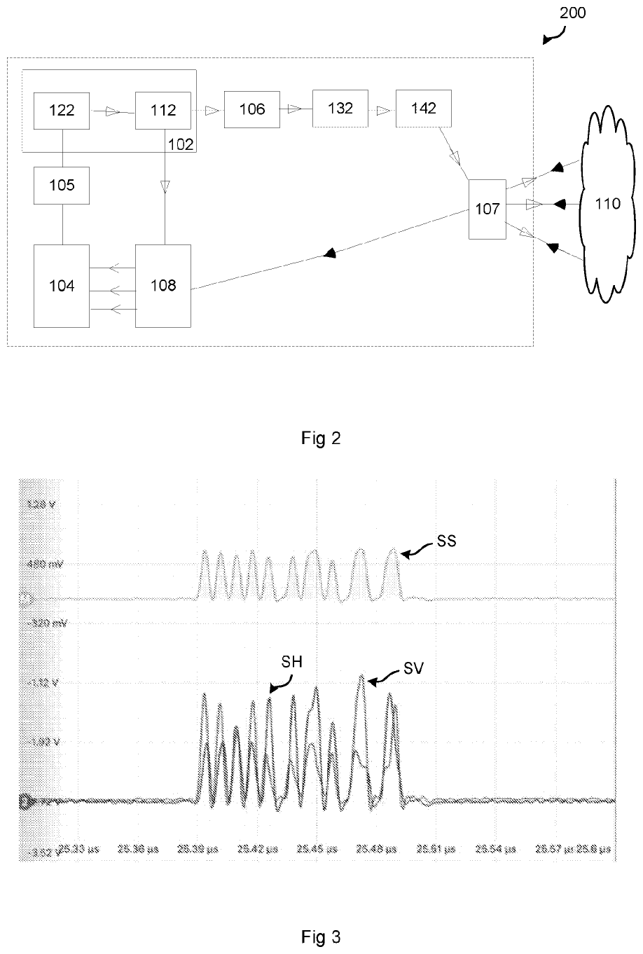

FIG. 2 illustrates an example arrangement of a spatial profiling system 200 with an optical signal collection and detection method according to the present disclosure. The system 200 includes a light source 102 configured to provide outgoing light at one or more wavelength channels. The light source may include a light emitter 122. For example, the light emitter 122 may be a wavelength-tunable laser of substantially continuous-wave (CW) light intensity, such as a wavelength-tunable laser diode, providing light of a tunable wavelength based on one or more electrical currents (e.g. the injection current into one or more wavelength tuning elements in the laser cavity) applied to the laser diode. In another example, the light emitter 122 may include a broadband laser source and a tunable spectral filter to provide substantially continuous-wave (CW) light intensity at the selected wavelength. The light source 102 is controlled, for example by the processing unit 105 to selectively provide the outgoing light at one or more wavelength channels. For example the light source 102 is controlled to provide outgoing light at a first set of one or more wavelength channels for a duration of time and then provide outgoing light at a second set of one or more wavelength channels, different from the first set for the same or different duration of time. In some embodiments the first set and the second set are mutually exclusive. Where the wavelength of the light source is adjusted from the first set or the second set, the homodyne detection technique acts as a time-synchronised spectral filter to facilitate detection of light at the adjusted wavelength(s). This combination is advantageous since adjusting the wavelength of the light source 102 automatically adjusts the filter wavelength in synchronisation, removing the need for a separate control at light detection. Further, in applications where fast wavelength adjustment is desired (e.g. to steer the optical beam or frustrate potential spoofing), the homodyne detection technique has a speed advantage over, for example, an electrically tunable filter which may lack the required response time. In some examples, such as semiconductor lasers whose emission wavelength is tunable based on carrier effects, the light source may be wavelength-tunable from the first set to the second set within 5 ms, such as under 500 μs, under 50 μs, under 5 μs or under 0.5 μs. The light source may be wavelength-tunable within a maximum range of 40 nm, and at a tuning speed within 8 nm/ms, such as under 80 nm/ms, under 800 nm/ms, under 8 nm/μs, or under 80 nm/μs. The light emitter 122 may be temporally incoherent (i.e. include temporally phase noise).

The light source 102 may also include at least one depolariser 112 to depolarise the outgoing light and output randomly (or in a pseudo-random order) polarised outgoing light (i.e. unpolarised outgoing light). The at least one depolariser may not require any power source, in other words the at least one depolariser may be a passive depolariser.

In the arrangement of FIG. 2, a LO signal is provided to the light receiver 104 for homodyne detection. For example, the unpolarised outgoing light may first enter a sampler 106 (e.g. an optical coupler or an optical splitter), where a first portion of the unpolarised outgoing light is provided to a modulator 132 for imparting a time-varying profile on the unpolarised outgoing light, for example a time varying intensity profile and a second portion (e.g. the remaining sample portion) of the light is provided to an optical subassembly 108 as a LO signal. At least one optical delay may be applied before one port or both ports of the optical subassembly 108 to appropriately synchronise the LO signal and the reflected signal at the optical subassembly 108.

In another example (not shown), the unpolarised light may first enter an input port of an optical switch and exit from one of two output ports, where one output port directs the light to the modulator 132 for imparting a time-varying profile on the unpolarised outgoing light and the other output port re-directs the light to the optical subassembly 108 at a time determined by a processing unit 105 as the LO signal. At least one optical delay (not shown) may be applied to synchronise the local oscillator signal and the reflected light at the optical subassembly 108.

In yet another example (not shown), the LO signal may be provided by a separate LO signal source controlled by the processing unit 105. The separate LO signal source includes a light source other than the light source 102 operating at the same or substantially the same centre wavelength as the light source 102 and at least one depolariser. The processing unit 105 may control the centre wavelength and power of the emitted light from the separate LO signal source. The processing unit may control the operational time and duration of the separate LO signal source.

FIG. 3 illustrates an example of experimental results regarding polarisation measurements of light from the light emitter after passing through a passive depolariser, with respect to signal duration. The unpolarised light is then arbitrarily modulated as an arbitrary signal. The signal traces labelled as SH and SV represent optical power of horizontal and vertical polarisation components of the arbitrary signal, respectively. The signal trace labelled as SS represents summation of horizontal and vertical polarisation components of the arbitrary signal, the optical power of which is steady over time. FIG. 3 shows that the depolariser may allow the spatial profiling system 200 to operate substantially independently of polarisation states of the outgoing light. In alternative embodiments, the light source may be configured to provide polarised light rather than depolarised light, for example, by passing light from the light emitter through a polariser before transmission. In these embodiments, a processor may be configured to determine a rate of depolarisation based on detected return of the polarised transmitted light. For example, a polarisation measurement module may receive the detected return and measure its polarisation state. The rate of depolarisation may be determined by comparing the measured polarisation state with that of the polarised transmitted light. The determined rate of depolarisation may facilitate inference of a property of a reflecting surface and hence object identification.

In the arrangement of FIG. 2, the modulated signal may be amplified by an optical amplifier 142, for example an Erbium-doped fibre amplifier (EDFA). The amplified modulated outgoing light is provided to a sensor head 107 for environment integration. In the embodiments described herein, the sensor head both sends and receives light into and from the environment respectively. In alternative embodiments, separate transmission and reception paths are used, which may be physically co-located or physically separate from each other.

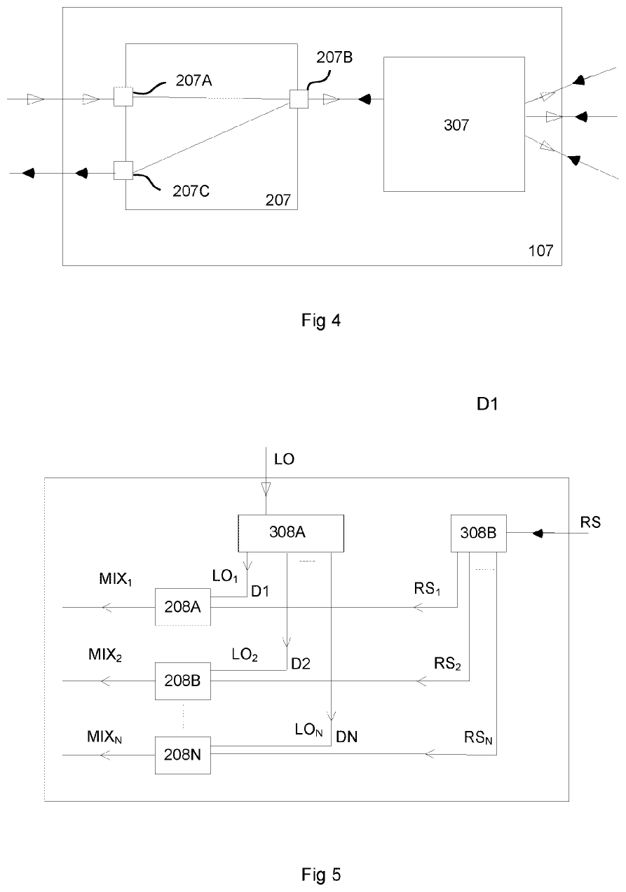

FIG. 4 illustrates one example arrangement of the sensor head 107. The sensor head 107 may include a coaxial transceiver module 207 and a beam director module 307. The coaxial transceiver module 207 is configured to (a) receive the unpolarised outgoing light via one or more input ports 207A, (b) send the received unpolarised outgoing light via one or more bidirectional ports 207B towards the beam director module 307, (c) receive the incoming light from the beam director module 307 via the bidirectional port(s) 207B, and (d) send the received incoming light via one or more output ports 207C to the optical subassembly 108. The outgoing light from the coaxial transceiver module 207 may be spatially coherent (but retain phase incoherence if an incoherent light emitter is used). The coaxial transceiver module 207 is arranged such that the outgoing path and the incoming path are spatially arranged to at least partially overlap, while the output 207C is spatially displaced from the one or more input ports 207A. The coaxial transceiver module 207 may be optically coupled with the optical subassembly 108 by few-mode fibres or multimode fibres. For example, the coaxial transceiver module 207 may be optically coupled with the optical amplifier 142 via a single mode fibre. Examples of the coaxial transceiver module 207 are disclosed in PCT application no. PCT/AU2018/051175 published as WO 2019/084610 A1 on 9 May 2019.

The beam director module 307 as illustrated in FIG. 4 is configured to (a) direct the unpolarised outgoing light towards the environment into one or more respective outgoing directions, based on the selected wavelength channel, and (b) direct the incoming light reflected from the environment 110 towards the coaxial transceiver module 207. The beam director module 307 may include expansion optics to enlarge the beam size for better divergence characteristics. The beam director module 307 may also include one or more dispersive elements, such as grating/s, prism/s and/or grism/s, to provide wavelength-dependent angular dispersion. Examples of beam directors that may be used as the beam director module 307 are disclosed in PCT application no. PCT/AU2016/050899 published as WO 2017/054036 A1 on 6 Apr. 2017, PCT application no. PCT/AU2017/051255 published as WO 2018/090085 A1 on 24 May 2018, and PCT application no. PCT/AU2018/050961 published as WO 2019/046895 A1 on 14 Mar. 2019. At least one characteristic associated with the detected light includes information for estimation (e.g. by the processing unit 105) of the spatial profile of the environment associated with the one or more outgoing directions.

FIG. 5 illustrates an arrangement of the optical subassembly 108. In the arrangement as shown in FIG. 5, an optical splitter 308A, for example a 1-to-N fibre coupler or a photonic lantern, divides the LO signal into multiple beams (i.e. LO₁, LO₂, . . . LO_{N}). An optical divider 308B divides the reflected signal (RS) from the sensor head 107 into multiple beams (i.e. RS₁, RS₂, . . . RS_{N}). In one example, in which the optical divider 308B is a photonic lantern, an input port of the photonic lantern 308B is coupled with the sensor head by a few-mode fibre or a multimode fibre supporting M light modes. The photonic lantern 308B is further optically coupled with N single mode fibres as output ports (i.e. N output ports), where the number of output ports N is equal to or less than the number of light modes M. In some embodiments the number of light modes M is selected between 3 and 10, or between 3 and 6. In those embodiments the number of output ports N may be selected to be equal to the number of light modes M. In another example, in which the optical divider 308B is a multi-core fibre whose Q multiple cores within an aperture at the input port transition to the respective cores of Q single mode fibres at the output ports. The optical subassembly 108 also includes multiple optical combiners (208A, 208B, . . . (208N or 208Q)) each combining one of the divided LO signals (LO₁, LO₂, . . . LO_{N or Q}) with one of the divided reflected signals (RS₁, RS₂, . . . RS_{N or Q}) and providing multiple combined beams (MIX₁, MIX₂, . . . MIX_{N or Q}). The multiple combined beams are provided to the light receiver 104. In some embodiments the number of combined beams provided to the light receiver 104 equals the number (N or Q) of output ports (which as mentioned above may equal the number of light modes M or Q). In this embodiment, the speckle noise (spatial phase noise) caused by spatial coherence of the light source manifests as intensity fluctuations across the collection aperture of the multimode fibre. The intensity fluctuations will determine into which of the M modes the light couples into, thus by simultaneously measuring each mode we can mitigate the effects of speckle noise. In some embodiments, the light source has a minimum spatial coherence such that the intensity difference between any two of the M or Q modes may be 3 dB or more, such as larger than 6 dB, 9 dB, 12 dB, 15 dB, 18 dB or 20 dB. It is often appreciated that every mode M or Q is at least partially excited. Later when mixing the M or Q modes with the N or Q LO signals, this may be done in such a way that each signal mixes with a different polarization and/or different temporal phase, thus mitigating the effects of their respective noise. For example, mixing with different temporal phases may be achieved by each of the LO signals traversing different delay elements D1 to DN. The delay elements may be different optical path lengths, for example different optical path lengths between the optical splitter 308A and the optical combiners 208A-N, to re-sample the local oscillator signal LO at different times. Where a light emitter 122 with temporal phase noise is used, the maximum temporal coherence length may be the round-trip path length of the reflected light (i.e. twice the range of the spatial profiling system). For example, where the range is 250 m, the maximum coherence length is 500 m, such as less than 100 m, 10 m, 1 m, 100 mm or 10 mm.

The optical power (P) of each divided beam may be equal (P_{MIX}_{₁}=P_{MIX}_{₂}= . . . =P_{MIX}_{_{N}}) or in certain ratios (i.e. P_{MIX}_{₁}=R₁·P_{MIX}, P_{MIX}_{₂}=R₂·P_{MIX} . . . P_{MIX}_{_{N}}=R_{N}·P_{MIX}, where R₁, R₂, . . . R_{N} can be any value provided that R₁+R₂+ . . . +R_{N}≤1). In some embodiments each non-zero value (of which there are a plurality) of R₁ to R_{N} is less than or equal to ⅓. In some embodiments each non-zero value (of which there are a plurality) of R₁ to R_{N} is about 1/40 or more. In some embodiments each are about 1/30 or more. In some embodiments there are three non-zero values of R₁ to R_{N}. In some embodiments there are more than three non-zero values of R₁ to R_{N}. In some embodiments, there are forty or less non-zero values of R₁ to R_{N} Each value of R₁ to R_{N} may be selected based on the number of output ports N of the photonic lantern.

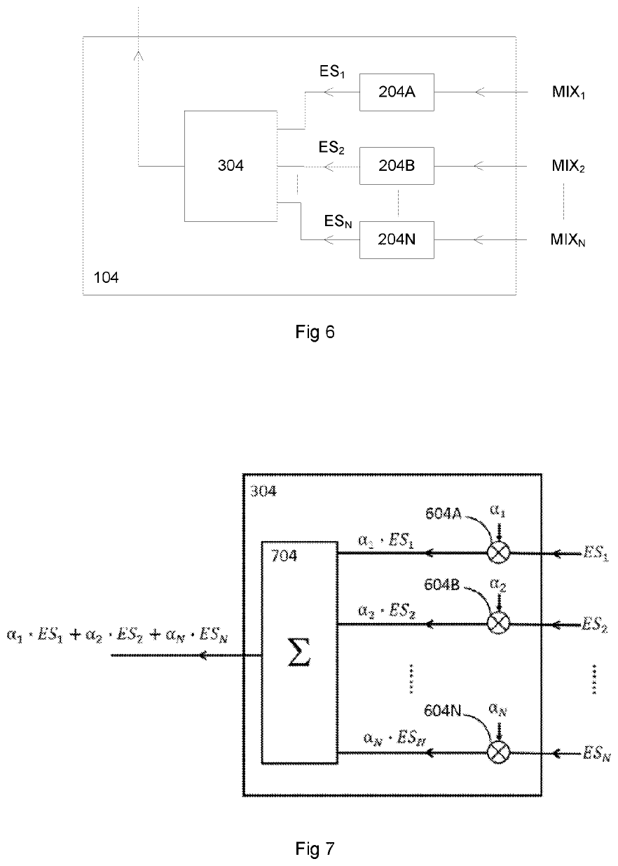

As illustrated in FIG. 6, the overall light receiver 104 includes a plurality of light detectors 204A, 204B, . . . 204N, each receiving one of the combined beams (e.g. MIX₁ is received by 204A, . . . MIX_{N} is received by 204N). Each of the multiple light detectors may be a PD for single ended detection or two PDs for balanced detection (not shown). Each light detector 204 detects a beat signal between the combined signal and converts the beat signal from the optical domain to the electrical domain and provides the corresponding electrical signal (ES₁, ES₂, . . . ES_{N}) to a receive combiner 304. The receive combiner 304 performs combining techniques and provides output to the processing unit 105 for determining the spatial profile of an environment. The receive combiner 304 may be implemented by the processing unit 105, or separate from the processing unit 105.

In one arrangement, the receive combiner 304 includes multiplexers that each multiply a weighting factor (α₁, α₂, . . . α_{N}) with each of the signals ES₁, ES₂, . . . ES_{N} as illustrated in FIG. 7. The receiver combiner 304 may also include a sum module 704 to sum up all the weighted signals (α₁·ES₁, α₂·ES₂, . . . α_{N}·ES_{N}) and output the summed signal to the processing unit 105 for range detection. In one example, each of the weighting factors may be equal. In another example, the weighting factors may be optimised to maximise the signal to noise ratio (SNR) of the summed signal (i.e. post-combining SNR). The receive combiner 304 may alternatively be in the form of a sum module that sums all of the received signals ES₁, ES₂, . . . ES_{N} without any weighting ability or function.

In one embodiment, the optical subassembly 108 may be in the form of a single photonic chip and the optical splitter (308A), optical divider (308B) and the optical combiners (208A, 208B, . . . 208N) may be integrated on the single photonic chip. The output ports of the optical subassembly 108 in the form of the single photonic chip each aligns to the corresponding light detector in the light receiver 104.

In the following discussion, the term Multimode Homodyne Detection (MHD) is used to describe the new receive architecture disclosed herein, to distinguish direct direction and homodyne detection.

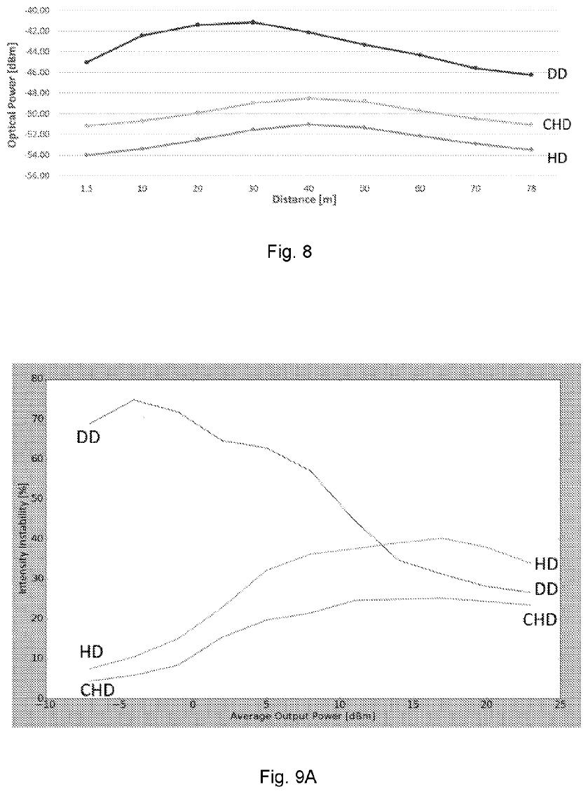

FIG. 8 illustrates results of average optical power of the reflected signal which would be collected by the different detection methods (i.e. DD, HD and MHD) with respect to distance to a target in a free space environment. In the experiment using MHD, the combining technique as illustrated in FIG. 7 was used where α₁=α₂=α_{N}=1. The optical power of the outgoing light to the environment 110 is measured as approximately 30 dBm for experimental demonstration. The target used in this experiment is a 90% reflective Lambertian target which was rotated to measure different parts of the target over time.

As shown in FIG. 8, DD is capable of collecting more optical power compared to the other two detection methods due to its larger collection aperture provided by the multimode fibre. Although MHD and HD have comparable collection apertures, MHD collects twice the amount of reflected light power than HD (˜3 dB). This may be because MHD is capable of mitigating the effects of speckle noise (or spatial phase noise). As also illustrated in FIG. 8, it is observed that the collection curves for MHD (and HD) become flattened compared to the collection curve of DD with decreasing target distance. This effect is due to spatial filtering which may reduce saturation of reflected optical power originating from objects/targets in the near field by limiting the amount of the collected optical power.

Different measurements were conducted as a function of optical power of the outgoing light to the environment. The target used for experimental demonstration is a 90% reflective rotating Lambertian target at a distance of about 80 metres.

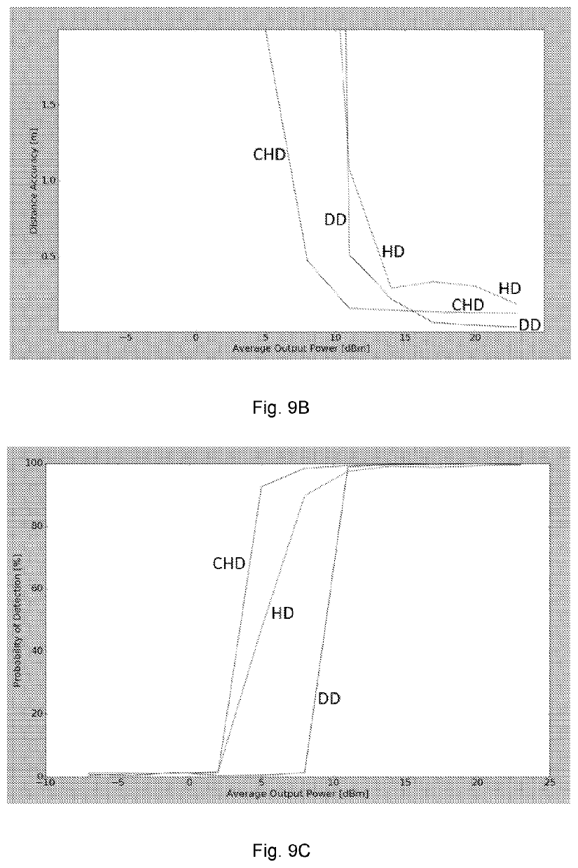

FIG. 9A illustrates intensity variation, or signal relative standard deviation (RSD) for the three different detection methods (i.e. DD, HD and MHD). Intensity instability refers to measurement precision, that is, how well the method returns the same intensity value from the same target. As the average optical power of the outgoing light to the environment is reduced, the signal disappears and the electrical noise floor. It is observed at −5 dBm of the average optical power of the outgoing light to the environment that both MHD and HD possess good noise floor compared to that of DD. This is due to the APD used in DD causing random signal spikes when being operated near its breakdown voltage. Accordingly, for large average optical power of the outgoing light to the environment, above 10 dBm, the measurement represents the signal RSD. As illustrated, MHD presents the most stable signal.

FIG. 9B illustrates distance accuracy measurements for the three detection methods. It is shown that at a strong average optical power of the outgoing light to the environment, i.e. around 20 dBm, DD provides approximately three times better distance accuracy than MHD and six times better than HD. Although MHD may reduce signal RSD compared to HD, the temporal phase incoherence for MHD is still notable compared to DD.

FIG. 9C illustrates measurements of probability of detection for the different detection methods. It is observed that both MHD and DD have similar receive sensitivity (˜2 dBm) which is better compared to that measured for DD (˜8 dBm). As further illustrated in FIG. 9C, HD has a slower roll off. This may be a result of it having a larger signal RSD, caused by temporal phase noise, spatial phase noise and/or polarisation dependence which is less prevalent for MHD and DD.

Now that arrangements of the present disclosure are described, it should be apparent to the skilled person in the art that at least one of the described arrangements may have one or more of the following advantages:
Enablement of frequency sensitive optical gain, i.e. improved optical interference immunity.
Enablement of polarisation independent detection system.
Reduction of signal RSD caused by one or more of polarisation dependence, temporal phase noise and spatial phase noise.
Mitigation of saturation effects in short range detection.
Improved collection efficiency (compared to HD).
Improved system dynamic range.
Feasible for applications requiring high-resolution detection and/or high scanning speeds.

It will be understood that the invention disclosed and defined in this specification extends to all alternative combinations of two or more of the individual features mentioned or evident from the text or drawings. All of these different combinations constitute various alternative aspects of the invention.

What is claimed is:

1. An optical system for spatial estimation, the system including:
at least one light emitter operatively connected to optical components, configured or collectively configured to provide:
outgoing light for spatial estimation, the outgoing light including:
a first set of one or more wavelength channels for a duration of time; and
a second set of one or more wavelength channels, different from the first set, for the same or a different duration of time;
at least one local oscillator signal usable for detection of the outgoing light, including the first set of one or more wavelengths and the second set of one or more wavelengths;
at least one beam director, for receiving the outgoing light and directing the outgoing light over free space into an environment remote from the beam director, the beam director configured to direct the first and second sets of one or more wavelengths in different directions;
components to receive light from at least the different directions, including reflected light of the first and second sets of one or more wavelengths, the components including:
at least one optical power splitter for splitting the power of the received light into a plurality of light signals each having non-zero power;
at least one optical combiner to combine a said local oscillator signal and each of the plurality of light signals, to provide a combined signal for detection of the reflected light;
wherein the at least one optical combiner and the at least one optical power splitter provide a plurality of said combined signals for detection;
a plurality of light detectors arranged to receive the plurality of combined signals and provide, based on the received combined signals, a plurality of electrical signals for processing into a spatial estimation of the remote environment.

2. The optical system of claim 1, wherein the first set of one or more wavelength channels transitions to the second set of one or more wavelength channels within 5 ms.

3. The optical system of claim 1, wherein the at least one local oscillator signal is derived from a light source including temporal phase noise, and the at least one optical combiner is configured to combine a first said local oscillator signal with a first temporal phase induced by the temporal phase noise with a first light signal of the plurality of light signals and combine a second said local oscillator signal with a second temporal phase induced by the temporal phase noise with a second light signal of the plurality of light signals.

4. The optical system of claim 3, wherein the light source has maximum temporal coherence length of 10 m or shorter.

5. The optical system of claim 3, wherein the light source has a minimum spatial coherence such that at least two of the plurality of light signals have an intensity difference of 3 dB or more.

6. The optical system of claim 1, wherein the optical components operatively connected to the light emitter include a depolariser operatively positioned to depolarise the outgoing light, whereby the outgoing light directed over free space into the environment is unpolarised light.

7. The optical system of claim 6, wherein the optical components operatively connected to the light emitter includes a depolariser operatively positioned to depolarise the at least one local oscillator signal for receipt by the optical combiner.

8. (canceled)

9. (canceled)

10. (canceled)

11. (canceled)

12. (canceled)

13. A method of detection of transmitted light reflected from an environment, the method comprising:
transmitting light from a light source to an environment, the light source including temporal phase noise;
receiving light reflected from the environment;
splitting the light reflected from the environment into a plurality of reflected light signals;
combining a local oscillator signal derived from the light source with each of the plurality of reflected light signals, to produce a plurality of mixed signals, comprising a first mixed signal produced based on a combination of a first local oscillator signal derived from the light source and a first of the plurality of reflected light signals and a second mixed signal produced based on a combination of a second local oscillator signal derived from the light source and a second of the plurality of reflected light signals, wherein the first and second local oscillator signals have different temporal phases induced by the temporal phase noise; and
detecting each of the plurality of mixed signals by a light receiver.

14. The method of claim 13, wherein the light source has maximum temporal coherence length of 10 m or shorter.

15. The method of claim 13, wherein the light source has a minimum spatial coherence such that at least two of the plurality of reflected light signals have an intensity difference of 3 dB or more.

16. The method of claim 13, wherein the received light reflected from an environment has a plurality of light modes and splitting the light reflected from the environment into the plurality of reflected light signals comprises splitting the received light into a plurality of light signals each with a single light mode.

17. The method of claim 13, comprising using as the first and second local oscillator signals, an unpolarised light signal comprising a sample of artificially generated outgoing light into the environment occasioning at least a portion of the light reflected from the environment.

18. The method of claim 13, comprising using as the first and second local oscillator signals, an unpolarised light signal operating at the same or substantially the same centre wavelength as artificially generated outgoing light into the environment occasioning at least a portion of the light reflected from the environment.

19. The method of claim 13, wherein the light reflected from the environment is received via a wavelength dependent bidirectional beam director and the outgoing light is provided into the environment via the bidirectional beam director, wherein reflected light shares at least part of an optical path of the outgoing light within the beam director.

20. An optical system including:
at least one optical assembly arranged to:
receive at least one optical local oscillator signal derived from a light source having temporal phase noise;
receive an optical remote light signal;
provide a plurality of optical combined signals based on the at least one local oscillator signal and the remote light signal, wherein each of the plurality of combined signals is formed based on a portion, less than all, of the received light signal, and comprise a first combined signal based on a first temporal phase of the at least one local oscillator signal induced by the temporal phase noise and a second combined signal based on the a second temporal phase of the least one local oscillator signal induced by the temporal phase noise, the second temporal phase different to the first temporal phase;
a plurality of light receivers arranged to receive the combined signals and provide, based on the received combined signals, a plurality of electrical signals carrying information indicative of at least one characteristic of the received reflected light signal; and
one or more electrical signal processors configured to receive the plurality of electrical signals and provide, based on the received electrical signals, an electrical output signal carrying information indicative of the at least one characteristic of the received light signal.

21. The optical system of claim 20, wherein the light source has maximum temporal coherence length of 10 m or shorter.

22. The optical system of claim 20, wherein the light source has a minimum spatial coherence such that at least two of the plurality of reflected light signals have an intensity difference of 3 dB or more.

23. The optical system of claim 20, wherein the plurality of light receivers utilise photodiode detectors.

24. The optical system of claim 20, wherein the optical remote light signal is received by the optical assembly via a few mode or multimode optical fibre.

25. The optical system of claim 24, wherein the optical assembly interfaces the few mode or multimode optical fibre with a plurality of single mode optical fibres, each single mode optical fibre carrying a said portion of the received light signal.

26. (canceled)

27. (canceled)

28. (canceled)

29. (canceled)

30. (canceled)

31. (canceled)

32. (canceled)
